(19) United States
(12) Patent Application Publication
(10) Pub. No.: US 2024/0365831 A1
(43) Pub. Date: Nov. 7, 2024

(54) GEL-LIKE FOOD AND METHOD FOR PRODUCING GEL-LIKE FOOD

(71) Applicant: The Nisshin OilliO Group, Ltd., Tokyo (JP)

(72) Inventors: Soyoka TOKUNAGA, Yokohama-shi (JP); Yasunobu SAITO, Yokohama-shi (JP)

(21) Appl. No.: 18/687,098

(22) PCT Filed: Aug. 31, 2022
(86) PCT No.: PCT/JP2022/032779

§ 371 Date: Feb. 27, 2024

(30) Foreign Application Priority Data
Sep. 3, 2021 (JP) 2021-144103

(51) Int. Cl. A23L 29/281; A23L 9/10; A23L 33/18; A23L 33/19

(52) U.S. Cl. CPC A23L 29/281; A23L 9/10; A23L 33/18; A23L 33/19

(57) ABSTRACT

A gel-like food which has a high protein content, is a uniform gel, and has swallowing properties of being easily ingestible by elderly people or people with difficulties in swallowing; and a method for producing the gel-like food. The gel-like food is produced by heating using thermal coagulation of proteins including 1-6 mass % of an egg white protein and 4-15 mass % of casein, the total protein content in the gel-like food being 5.5-25 mass %.

### TECHNICAL FIELD

The present invention relates to a gel-like food and a method for producing a gel-like food.

### BACKGROUND ART

Elderly people and people with difficulties in swallowing sometimes find it difficult to sufficiently consume a normal meal, and there is a risk that a low nutritional state may occur due to the reduced amount of food consumed. In particular, it is said that insufficient ingestion of proteins is likely to result in frail health due to a decrease in muscles, which further results in a decrease in exercise and cognitive function, and it is important to satisfy a required ingestion amount in three meals. In order to deal with such a problem, various food products with increased density of various nutrients have been developed so that sufficient nutrients can be taken with a small amount of food. Such foods are adjusted to have an appropriate texture by blending a gelling agent to facilitate ingestion. However, in the gel-like food having an increased protein content, blending a gelling agent causes vigorous pneumatization during the production process, gelation sometimes does not proceed, or the gel-like food separates by heat treatment into a layer of gel by the gelling agent and a layer of gel by thermal coagulation of proteins. Thus, it was difficult to obtain a gel-like food having a desired texture.

As a gel-like food using thermal coagulation of a protein without using a gelling agent, there has been reported a gel-like food including 1 to 6% by weight of a protein, 6 to 15% by weight of a lipid, and 0.1 to 2% by weight of an emulsifier and/or two or more types of phospholipids, wherein a gradient of solid fat contents at 10 to 30° C. of an extracted lipid in the food is 2.1 to 5, and a lauric acid content is 0.01 or more and 45% or less (Patent Document 1). In addition, there has been reported a method for producing a gel-like food, the method including providing sterile-filled soybean milk that has sterilized without heating to an extent that a soybean curd is separated, adding 0.1 to 0.8% of a coagulant composition to the sterile-filled soybean milk, and heating the sterile-filled soybean milk in a microwave oven (Patent Document 2). However, in a gel-like food having a further increased protein content, there is room for improvement in imparting swallowing physical properties that facilitate elderly people or people with difficulties in swallowing in intaking the gel-like food.

### CITATION LIST

### Patent Document

Patent Document 1: Japanese Unexamined Patent Application, Publication No. 2019-176749
Patent Document 2: Japanese Unexamined Patent Application, Publication No. H11-169125

### DISCLOSURE OF THE INVENTION

### Problems to be Solved by the Invention

In view of the above problems, it is an object of the present invention to provide a gel-like food having a high protein content, being a uniform gel, and having swallowing physical properties that facilitate elderly people or people with difficulties in swallowing in intaking the gel-like food, and to provide a method for producing the gel-like food.

### Means for Solving the Problems

The present inventors have found that a gel-like food having a high protein content, being a uniform gel, and having swallowing physical properties that facilitate elderly people or people with difficulties in swallowing in intaking the gel-like food can be obtained by gelling a mixture including specific amounts of an egg white protein and casein by using thermal coagulation of the protein, arriving at the completion of the present invention. Specifically, the present invention provides the following.

A first aspect of the present invention relates to a gel-like food using thermal coagulation of a protein, including 1 to 6% by mass of an egg white protein and 4 to 15% by mass of casein, in which a total protein content in the gel-like food is 5.5 to 25% by mass. A second aspect of the present invention relates to the gel-like food as described in the first aspect, in which the casein includes sodium caseinate and calcium caseinate. A third aspect of the present invention relates to the gel-like food as described in the first or second aspect, including a collagen peptide. A fourth aspect of the present invention relates to the gel-like food as described in any one of the first to third aspects, in which the gel-like food is for elderly people or people with difficulties in swallowing. A fifth aspect of the present invention relates to a method for producing the gel-like food as described in any one of the first to fourth aspects, including coagulating the protein by heating. A sixth aspect of the present invention relates to a method for producing a gel-like food including 1 to 6% by mass of an egg white protein and 4 to 15% by mass of casein, in which a total protein content in the gel-like food is 5.5 to 25% by mass and the method includes coagulating the protein by heating. A seventh aspect of the present invention relates to the method for producing a gel-like food as described in the sixth aspect, in which the casein includes sodium caseinate and calcium caseinate. An eighth aspect of the present invention relates to the method for producing a gel-like food as described in the sixth or seventh aspect, in which the gel-like food includes a collagen peptide.

### Effects of the Invention

According to the present invention, it is possible to provide a gel-like food having a high protein content, being a uniform gel, and having swallowing physical properties that facilitate elderly people or people with difficulties in swallowing in intaking the gel-like food, and a method for producing the gel-like food.

### Preferred Mode for Carrying Out the Invention

Hereinafter, specific embodiments of the present invention will be described in detail, but the present invention is not limited to the following embodiments, and the present invention can be carried out with appropriate modifications within the scope of the object of the present invention. Note that preferred embodiments, more preferred embodiments, and the like exemplified below can be appropriately combined with each other regardless of expressions such as “preferably” and “more preferably”. In addition, the descriptions of numerical ranges are mere examples, and ranges produced by appropriately combining the upper limit and the lower limit of each range and numerical values of the Examples can be also preferably used regardless of expressions such as “preferably”, “more preferably”, or the like. Further, the terms “including” and “containing” may be interpreted as “essentially consisting of” or “consisting of only”, as appropriate.

### [Gel-Like Food]

The gel-like food of the present invention is a gel-like food gelled by utilizing thermal coagulation of a protein (that is, the gel-like food is in a state where the protein is thermally coagulated and fluidity is lost) and includes 1 to 6% by mass of an egg white protein and 4 to 15% by mass of casein, and a total protein content in the gel-like food is 5.5 to 25% by mass. Specific examples of the gel-like food of the present invention include foods, such as jelly, puddings, jelly beverages, paste seasonings and the like, and foods in an embodiment similar to the above. The gel-like food of the present invention can also be added to other foods as a raw material for processing. A packaging form of the gel-like food of the present invention is not particularly limited, and can be randomly selected depending on the purpose as long as it is usually used for jelly, puddings, jelly beverages, paste seasonings and the like. Examples thereof include cups, cans, paper containers, plastic containers, aluminum pouches, bottles, and the like.

The gel-like food of the present invention preferably has a total protein content of 8 to 24% by mass, more preferably 10 to 24% by mass, still more preferably 15 to 23% by mass, and most preferably 18 to 22% by mass. When the total protein content is in the above range, protein intake efficiency can be further increased. The total protein content in the gel-like food of the present invention can be determined by a Kjeldahl method. In the present invention, the gel-like food having a high protein content refers to one having a total protein content in the gel-like food of preferably 5% by mass or more, and more preferably 10% by mass or more.

The gel-like food of the present invention preferably has a solid content of 5 to 50% by mass, more preferably 10 to 45% by mass, still more preferably 15 to 40% by mass, and most preferably 20 to 35% by mass. When the content of the solid content is in the above range, the food has a more excellent effect in imparting swallowing physical properties that facilitate elderly people or people with difficulties in swallowing in intaking the gel-like food. The solid content in the gel-like food of the present invention refers to a remaining mass of the gel-like food from which moisture has been removed. The solid content in the gel-like food of the present invention can be determined by a conventional dry weight reduction method (105° C., 4 hours).

The gel-like food of the present invention preferably has a hardness of 1,500 to 25,000 N/m², more preferably 2,000 to 20,000 N/m², still more preferably 2,500 to 16,000 N/m², and most preferably 5,000 to 15,000 N/m². When the hardness of the gel-like food of the present invention is in the above range, the gel-like food is more excellent in the physical properties such that even elderly people and people with difficulties in swallowing can easily crush the gel-like food by the tongue.

The gel-like food of the present invention preferably has adhesiveness of 2,000 J/m³ or less, more preferably 0 to 1,500 J/m³, and most preferably 0 to 1,000 J/m³. When the adhesiveness of the gel-like food of the present invention is in the above-mentioned range, the gel-like food has more excellent physical properties such that even elderly people and people with difficulties in swallowing can easily swallow the gel-like food.

The gel-like food of the present invention preferably has a cohesiveness of 0.2 to 0.9, more preferably 0.3 to 0.8, and most preferably 0.4 to 0.7. The gel-like food of the present invention having a cohesiveness included in the above-mentioned range has a more excellent effect in imparting swallowing physical properties that facilitate elderly people or people with difficulties in swallowing in intaking the gel-like food.

The hardness, adhesiveness, and cohesiveness are measured, for example, by filling a container having a diameter of 30 mm and a height of 15 mm with the gel-like food of the present invention to a height of 15 mm, and using a rheometer, under the conditions of a cylindrical plunger having a diameter of 16 mm, a compression speed of 10 mm/sec, a clearance of 5 mm, and 20° C. Next, the hardness, adhesiveness, and cohesiveness can be determined from the obtained texture curve.

### [Egg White Protein]

The egg white protein of the present invention has thermal coagulation properties. As the egg white protein of the present invention, an egg white processed product obtained by purification, extraction, concentration or dilution of egg whites separated from egg yolks obtained by egg cracking may be used, as long as the egg white protein has thermal coagulation properties. Further, as the egg white protein of the present invention, an egg white processed product may be used in which the egg white protein thereof has a lower molecular weight than a protein of a raw egg white due to an enzyme treatment or the like, or conversely, in which the egg white protein binds to a protein of the egg white or to a protein other than the egg white, such as a milk protein added separately, and has a higher molecular weight than the protein of the raw egg white, as long as the egg white processed product has thermal coagulation properties. Further, two or more types of egg white processed products may be used in combination. The egg white protein in the present invention is preferably an egg white protein that is gelled (a state in which fluidity is lost) when an aqueous solution including 10% by mass of the egg white protein is heated at 90° C. for 30 minutes and then is cooled down to room temperature.

The egg white processed product has a content of the protein of preferably 70% by mass or more, more preferably 70% by mass to 95% by mass, and most preferably 75% by mass to 90% by mass. The content of the protein can be determined by the Kjeldahl method. As the egg white processed product, a commercially available product can be used. For example, trade names “Sunkirara AD” and “Sunkirara RS” manufactured by TAIYO KAGAKU CO., LTD. and “Dried Egg White M Type No. 200” manufactured by Kewpie Egg Corporation can be mentioned.

In the gel-like food of the present invention, a content of the egg white protein is 1 to 6% by mass, preferably 1 to 5% by mass, more preferably 1.1 to 4% by mass, and most preferably 1.2 to 3% by mass. The egg white protein content in the above-mentioned range has a more excellent effect in imparting swallowing physical properties that facilitate elderly people or people with difficulties in swallowing in intaking the gel-like food. Note that when the egg white processed product is used as a source of the egg white protein, the blending amount of the egg white processed product may be adjusted so that the content of the egg white protein in the gel-like food of the present invention is a desired content in consideration of the content of the protein in the egg white processed product. For example, in the gel-like food of the present invention, the content of the egg white processed product is preferably 1.2 to 7% by mass, more preferably 1.3 to 6% by mass, still more preferably 1.35 to 5% by mass, and most preferably 1.4 to 4% by mass.

### [Casein]

Casein of the present invention is a phosphoprotein that constitutes the main component of a milk protein. As the casein of the present invention, a casein processed product may be used, the casein processed product being obtained by separating casein from bovine milk, defatted milk, or the like by a known method and subjecting the separated casein to purification, extraction, concentration, or the like. A casein-derived protein of the present invention may be in the form of a salt (casein salt), or a casein processed product including one or two or more casein salts selected from sodium caseinate, potassium caseinate, calcium caseinate, magnesium caseinate, or the like may be used. Further, two or more types of the casein processed products may be used in combination. It is preferable that the casein of the present invention does not cause gelation (a state where fluidity is lost) when an aqueous solution including 10% by mass of casein is heated at 90° C. for 30 minutes and then cooled to room temperature.

The casein processed product includes a protein in a content of preferably 70% by mass or more, more preferably 75 to 99% by mass, and most preferably 80 to 95% by mass. The content of a protein can be determined by the Kjeldahl method. As the casein processed product, a commercially available product can be used. For example, trade names “TATUA 100” and “TATUA 400” manufactured by Tatua Japan Co., Ltd., and trade names “Sodium Caseinate S” and “Calcium Caseinate S” manufactured by Nippon Shinyaku Co., Ltd. can be mentioned.

In the gel-like food of the present invention, the content of casein is 4 to 15% by mass, preferably 5 to 13% by mass, more preferably 6 to 12% by mass, and most preferably 7 to 11% by mass. The gel-like food of the present invention having a content of casein included in the above-mentioned range has a more excellent effect in imparting swallowing physical properties that facilitate elderly people or people with difficulties in swallowing in intaking the gel-like food. Specifically, since a thermally coagulated (gelled) egg white protein is brittle and has physical properties of easily disintegrating and thus by incorporating casein, it is possible to reduce the brittleness of the gel and the easiness of disintegration, imparting more excellent swallowing physical properties suitable for elderly people and people with difficulties in swallowing. Note that when a casein-processed product is used as a supply source of casein, the blending amount of the casein-processed product may be adjusted in consideration of the protein content in the casein-processed product so that the casein content in the gel-like food of the present invention has a desired content. For example, in the gel-like food of the present invention, the content of the casein processed product is preferably 4.5 to 17% by mass, more preferably 6 to 14% by mass, still more preferably 7 to 13% by mass, and most preferably 8 to 12% by mass.

Casein in the present invention preferably includes sodium caseinate and calcium caseinate from the viewpoint of easy adjustment of the physical properties of the gel-like food of the present invention. When the gel-like food of the present invention includes sodium caseinate and calcium caseinate, the blending amounts of sodium caseinate and calcium caseinate may be adjusted so that the protein derived from the sodium caseinate and calcium caseinate has a desired content within the range of the preferable content of casein in the gel-like food of the present invention.

The content of sodium caseinate in the gel-like food of the present invention is preferably 2 to 8% by mass, more preferably 3 to 7% by mass, and most preferably 4 to 6% by mass. In the gel-like food of the present invention, the content of calcium caseinate is preferably 2 to 8% by mass, more preferably 3 to 7% by mass, and most preferably 4 to 6% by mass. Further, when the gel-like food of the present invention includes sodium caseinate and calcium caseinate, a mass ratio thereof (sodium caseinate:calcium caseinate) is preferably 30:70 to 70:30, more preferably 40:60 to 60:40, and most preferably 45:55 to 55:45. The gel-like food of the present invention having the content and the mass ratio of sodium caseinate and calcium caseinate included in the above-mentioned ranges has a more excellent effect in imparting swallowing physical properties that facilitate elderly people or people with difficulties in swallowing in intaking the gel-like food.

### [Collagen Peptide]

A collagen peptide of the present invention is a collagen peptide derived from cows, pigs, fish, and the like and subjected to degradation treatment so as to have an average molecular weight of 10,000 or less. The collagen peptide can be used alone or in combination of two or more types thereof. Commercially available products can be used as the collagen peptide. For example, “FCP” and “GELITA SOL NPS” manufactured by Nippi Incorporated, “F5000HD”, “P5000HD”, “F2000HD”, and “P2000HD” manufactured by Rousselot, and the like can be mentioned.

The average molecular weight of the collagen peptide in the present invention is as a weight average molecular weight (Mw), and is preferably 1,000 to 10,000, more preferably 1,500 to 7,000, and most preferably 2,000 to 5,000. The gel-like food of the present invention having an average molecular weight included in the above-mentioned range can provide a gel-like food with a more excellent effect that elderly people or people with difficulties in swallowing can easily intake. Note that the weight average molecular weight can be determined in accordance with a method described in “20-2 Average Molecular Weight” of version 10th of Test Method for Photographic Gelatin (PAGI method) by Gelatin Manufactures Association of Japan. The PAGI method is a method of obtaining a chromatogram of collagen peptide by gel filtration using high performance liquid chromatography and estimating a molecular weight distribution thereof.

The collagen peptide in the present invention preferably has a protein content of 70 mass % or more, more preferably 70 to 100 mass %, still more preferably 80 to 98 mass %, and most preferably 85 to 95 mass %. The content of protein can be determined by the Kjeldahl method.

The gel-like food of the present invention can preferably include a collagen peptide when the total protein content is 10% by mass or more (preferably 15% by mass or more). The content of the collagen peptide in the gel-like food of the present invention may be adjusted in consideration of the protein content in the collagen peptide so that the gel-like food of the present invention has a desired total protein content, and is preferably 5 to 17 mass %, more preferably 7 to 15 mass %, and most preferably 8 to 10 mass %. When the content of the collagen peptide is in the above range, the physical properties of the gel-like food of the present invention can be more easily adjusted.

### [Other Materials]

The gel-like food of the present invention may include food additives such as protein materials (e.g., milk whey concentrates, soy proteins) other than the egg white protein, casein, and the collagen peptide, various nutrient components such as sugars, oils, vitamins, and minerals, and emulsifiers, stabilizers, flavors, relish materials, and the like, depending on the purpose, as long as the effect of the present invention is not impaired.

The gel-like food of the present invention may include a saccharide. Specific examples of the saccharide include sugars, sucrose, isomerized liquid sugars, fructose, glucose, maltose, starch syrup, honey, converted sugars, lactose, syrup, oligosaccharides and the like. The content of the saccharide in the gel-like food of the present invention is preferably 3 to 18% by mass, more preferably 5 to 15% by mass, and most preferably 7 to 12% by mass. With the gel-like food of the present invention including sugars included in the above-mentioned range, the physical properties thereof can be more easily adjusted.

The gel-like food of the present invention may include a gelling agent (polysaccharide, artificial starch, etc.) other than proteins, and the content of the gelling agent other than proteins is preferably 0.1% by mass or less, more preferably 0.05% by mass or less, and most preferably the gel-like food of the present invention does not include a gelling agent other than proteins. When the content of the gelling agent other than proteins is in the above range, a gel-like food having a uniform gel can be more easily obtained.

The gel-like food of the present invention preferably has a water content of 50 to 95 mass %, more preferably 55 to 90 mass %, still more preferably 60 to 85 mass %, and most preferably 65 to 80 mass %. When the content of water is in the above-mentioned range, the gel-like food of the present invention has a more excellent effect in imparting swallowing physical properties that facilitate elderly people or people with difficulties in swallowing in intaking the gel-like food.

### [Application of Gel-Like Food]

Since hardness, cohesiveness, and adhesiveness of the gel-like food of the present invention can be adjusted to have the physical properties described above, the gel-like food of the present invention can be suitably used in applications for elderly people (for foods for elderly people) or for people with difficulties in swallowing (for foods for people with difficulties in swallowing). Here, the elderly people in the present invention refer to those 60 or more years old, preferably 65 or more years old, and most preferably 70 or more years old. In the present invention, people with difficulties in swallowing refer to those having any problem in swallowing. For example, elderly people with reduced swallowing ability and people with cerebral nerve diseases, or oral diseases can be included.

### [Method for Manufacturing Gel-Like Food]

The method for producing the gel-like food of the present invention includes coagulating a protein by heating when producing the “gel-like food of the present invention” described above. Specifically, the production method includes preparing a solution including an egg white protein and casein, filling a container with the solution, and then heating the solution to a temperature equal to or higher than a coagulation temperature of the protein to thermally coagulate the solution into a gel. In the method for producing a gel-like food of the present invention, heating conditions can be appropriately set so that the protein in the gel-like food is gelled to have desired physical properties. The heating temperature is preferably 60 to 150° C. and more preferably 80 to 130° C. and the heating time is preferably 10 to 90 minutes and more preferably 20 to 60 minutes. Further, the heating is preferably performed in a mode where a container of preferably 5 to 500 mL, more preferably 10 to 200 mL, and most more preferably 20 to 100 mL is filled with the gel-like food of the present invention in a full volume. The gel-like food of the present invention can be produced in general production equipment for gel-like foods under general production conditions of gel-like foods.

In the method for producing a gel-like food of the present invention, the coagulating the protein by heating may be performed as a sterilization treatment. The sterilization treatment is not particularly limited as long as it is a method widely used in the sterilization treatment of processed foods, and examples thereof include a UHT treatment and a retort treatment.

The contents, preferred embodiments, and the like of the egg white protein, casein, the collagen peptide, whole protein, and solid content in the method for producing a gel-like food of the present invention are the same as those of the above-described “gel-like food of the present invention”.

### EXAMPLES

Hereinafter, the present invention will be described more specifically with reference to Examples, but the scope of the present invention is not limited to these Examples.

### [Production of Gel-Like Food]

The gel-like foods with formulations shown in Tables 1 to 3 were produced. Specifically, about 60% of water to be blended was heated to 90° C. and a total amount of sodium caseinate was dissolved in it. Next, the remaining water (room temperature) was charged, and then all raw materials were charged while stirring, and dissolved to obtain a uniform solution. The prepared solution was degassed, filled into a 25 mL heat-resistant plastic container, sealed, and heat-coagulated (121° C., 30 minutes) using an autoclave to obtain gel-like foods (Examples 1 to 8, Comparative Examples 1 to 3).

The following materials were used as the raw materials shown in Tables 1 to 3.
Egg white processed product-1: trade name “Sunkirara AD”, manufactured by TAIYO KAGAKU CO., LTD., protein content: 78% by mass, moisture content: 7% by mass
Egg white processed product-2: trade name “Dry Egg White M Type No. 200”, manufactured by Kewpie Egg Corporation, protein content: 86.5% by mass, moisture: 7% by mass
Sodium caseinate: trade name “TATUA 100” manufactured by Tatua Japan Co., Ltd., protein content: 93.3% by mass, moisture content: 4.3% by mass
Calcium caseinate: trade name “TATUA 400”, manufactured by Tatua Japan Co., Ltd., protein content: 91.6% by mass, moisture content: 4.2% by mass
Collagen peptide: trade name “GELITA SOL NPS”, manufactured by Nippi, protein content: 90% by mass, moisture content: 7% by mass
Sucralose: trade name “SU-600”, manufactured by Tsuruya Chemical Industries, Ltd.
Sugar: trade name “Super Refined Sugar”, manufactured by Mitsui Sugar Co., Ltd., moisture content: 0.8% by mass

### [Evaluation of Gel-Like Food]

### 1) Visual Evaluation of Appearance

A panel consisting of five panelists visually observed the appearance of the gel-like foods prepared above and evaluated them according to the following evaluation criteria. The results are shown in Tables 1 to 3.

### (Evaluation Standards)

o: formation of a heterogeneous gel and/or separation of layers of gel is not observed and a uniform gel is formed.
x: any one of no gelation, heterogeneous gel formation, or separation of layers of gel is observed.

### 2) Measurement of Hardness, Adhesiveness, and Cohesiveness

Each of the gel-like foods prepared above was filled into a container having a diameter of 30 mm and a height of 15 mm, to a height of 15 mm, left to stand at 20° C. for 10 minutes, and then measurement was performed using a rheometer (RE-33005 RHEONER, manufactured by Yamaden Co., Ltd.). The hardness (N/m²), the adhesiveness (J/m³), and the cohesiveness were measured using a cylindrical plunger made of a resin and having a diameter of 16 mm, under conditions of a compression rate of 10 mm/sec and a clearance of 5 mm. The results were evaluated according to the following evaluation criteria. The evaluation results are shown in Tables 1 to 3. In Comparative Example 2, since gelation did not occur, evaluations were not performed.

### (Criteria for Evaluation of Hardness)

o: 1,500 to 25,000 N/m² (hardness suitable for foods for people with difficulties in swallowing)
x: less than 1,500 N/m² or greater than 25,000 N/m² (too soft or too hard hardness unsuitable for foods for people with difficulties in swallowing)

### (Criteria for Evaluation of Adhesiveness)

⊙: 0 to 1,000 J/m³ (adhesiveness more suitable for foods for people with difficulties in swallowing)
o: 1,001 to 2,500 J/m³ (adhesiveness suitable for foods for people with difficulties in swallowing)
x: 2,501 J/m³ or more (too strong adhesiveness strength and unsuitable for foods for people with difficulties in swallowing)

### (Criteria for Evaluation of Cohesiveness)

O: 0.2 to 0.9 (cohesiveness suitable for foods for people with difficulties in swallowing)
x: less than 0.2 or greater than 0.9 (too weak or too strong and unsuitable for foods for people with difficulties in swallowing)

### 3) Sensory Test of Swallowing Physical Properties

Five grams of each gel-like food prepared above was taken by each of five expert panelists and evaluation was made by discussion of the five expert panelists according to the following criteria. The evaluation results are shown in Tables 1 to 3.

### (Criteria for Evaluation of Swallowing Physical Properties)

∘: easy to swallow and suitable for foods for people with difficulties in swallowing
×: difficult to swallow and unsuitable for foods for people with difficulties in swallowing.

The “casein content” in Tables 1 to 3 denotes a total content (mass %) of proteins contained in sodium caseinate and calcium caseinate as the raw materials. The “total protein content” in Tables 1 to 3 denotes a total content (mass %) of proteins contained in the egg white processed product, sodium caseinate, calcium caseinate, and collagen peptide as the raw materials. “Solid content” in Tables 1 to 3 denotes a total content (mass %) of raw materials other than water, excluding moisture.

TABLE 1

| (mass %) | | Example1 | Example2 | Example3 | Example4 |
|---|---|---|---|---|---|
| White egg processed | | 6.00 | | 2.00 | 2.00 |
| product-1 | | | | | |
| White egg processed | | | 2.20 | | |
| product-2 | | | | | |
| Sodium caseinate | | 3.00 | 4.50 | 5.00 | 5.00 |
| Calcium caseinate | | 3.00 | 6.70 | 7.00 | 5.00 |
| Collagen peptide | | | 9.00 | 8.00 | 10.00 |
| Sucralose | | 0.05 | 0.05 | 0.05 | 0.05 |
| Sugar | | 10.00 | 5.00 | 8.00 | |
| Water | | 77.95 | 72.55 | 69.95 | 77.95 |
| Total | | 100.00 | 100.00 | 100.00 | 100.00 |
| Casein content(mass %) | | 5.55 | 10.34 | 11.08 | 9.25 |
| Total protein | | 10.23 | 20.34 | 19.84 | 19.81 |
| content(mass %) | | | | | |
| Solid content(mass %) | | 21.30 | 26.15 | 28.78 | 20.79 |
| Evaluation | Appearance | ◯ | ◯ | ◯ | ◯ |
| | Hardness | ◯ (16950) | ◯ (9707) | ◯ (9560) | ◯ (2780) |
| | (N/m²) | | | | |
| | Adhesiveness | ◯ (1540) | ⊚ (977) | ⊚ (954) | ⊚ (587) |
| | (J/m³) | | | | |
| | Cohesiveness | ◯ (0.6) | ◯ (0.5) | ◯ (0.5) | ◯ (0.5) |
| | Functional | ◯ | ◯ | ◯ | ◯ |
| | Test | | | | |

TABLE 2

| (mass %) | | Example5 | Example6 | Example7 | Example8 |
|---|---|---|---|---|---|
| White egg processed | | 2.00 | 3.00 | 2.00 | 3.00 |
| product-1 | | | | | |
| Sodium caseinate | | 5.00 | 5.00 | 5.00 | 4.50 |
| Calcium caseinate | | 5.00 | 5.00 | 5.00 | 4.50 |
| Collagen peptide | | 10.00 | 10.00 | 15.00 | 15.00 |
| Sucralose | | 0.05 | 0.05 | 0.05 | 0.05 |
| Sugar | | 10.00 | 10.00 | 10.00 | 10.00 |
| Water | | 67.95 | 66.95 | 62.95 | 62.95 |
| Total | | 100.00 | 100.00 | 100.00 | 100.00 |
| Casein content(mass %) | | 9.25 | 9.25 | 9.25 | 8.32 |
| Total protein | | 19.81 | 20.59 | 24.31 | 24.16 |
| content(mass %) | | | | | |
| Solid content(mass %) | | 30.71 | 31.64 | 35.36 | 35.33 |
| Evaluation | Appearance | ◯ | ◯ | ◯ | ◯ |
| | Hardness | ◯ (3219) | ◯ (9194) | ◯ (7316) | ◯ (9048) |
| | (N/m²) | | | | |
| | Adhesiveness | ⊚ (628) | ◯ (1261) | ◯ (1018) | ◯ (1203) |
| | (J/m³) | | | | |
| | Cohesiveness | ◯ (0.6) | ◯ (0.6) | ◯ (0.6) | ◯ (0.6) |
| | Functional | ◯ | ◯ | ◯ | ◯ |
| | Test | | | | |

TABLE 3

| | | Comparative | Comparative | Comparative |
|---|---|---|---|---|
| (mass %) | | Example1 | Example2 | Example3 |
| White egg processed | | 5.00 | | 7.50 |
| product-1 | | | | |
| Sodium caseinate | | | 6.00 | 3.00 |
| Calcium caseinate | | | 6.00 | 3.00 |
| Collagen peptide | | 18.00 | 10.00 | 10.00 |
| Sucralose | | 0.05 | 0.05 | 0.05 |
| Sugar | | 10.00 | 10.00 | 10.00 |
| Water | | 66.95 | 67.95 | 66.45 |
| Total | | 100.00 | 100.00 | 100.00 |
| Casein content(mass %) | | 0.00 | 11.09 | 5.55 |
| Total protein | | 20.10 | 20.09 | 20.40 |
| content(mass %) | | | | |
| Solid content(mass %) | | 31.36 | 30.76 | 31.99 |
| Evaluation | Appearance | ∘ | x | ∘ |
| | Hardness | x (33090) | (No | x (46238) |
| | (N/m²) | | gelation) | |
| | Adhesiveness | ∘ (1714) | (Not | ∘ (2439) |
| | (J/m³) | | carried out) | |
| | Cohesiveness | ∘ (0.4) | (Not | ∘ (0.5) |
| | | | carried out) | |
| | Functional | x | (Not | x |
| | Test | | carried out) | |

From the results in Tables 1 to 3, the gel-like foods (Examples 1 to 8) of the present invention including 2 to 6 mass % of the egg white processed product (1.6 to 4.7 mass % as the egg white protein), 5.55 to 11.08 mass % of casein, and having a total protein content of 10.23 to 24.31 were uniform gels and had swallowing physical properties that facilitate elderly people or people with difficulties in swallowing in intaking the gel-like food. On the other hand, the gel-like food (Comparative Example 1) gelled by the egg white protein alone without including casein was too hard and was unacceptable as a food for elderly people and people with difficulties in swallowing. Similarly, the gel-like food (Comparative Example 3) including 7.5% by mass of the egg white protein was also a hard gel due to a large amount of the egg white protein and was unacceptable as a food for elderly people and people with difficulties in swallowing. In addition, the food including no egg white protein (Comparative Example 2) did not form a gel.

1. A gel-like food using thermal coagulation of a protein, comprising 1 to 6% by mass of an egg white protein and 4 to 15% by mass of casein, wherein a total protein content in the gel-like food is 5.5 to 25% by mass.

2. The gel-like food according to claim 1, wherein the casein includes sodium caseinate and calcium caseinate.

3. The gel-like food according to claim 1, further comprising a collagen peptide.

4. (canceled)

5. The gel-like food according to claim 1, wherein the gel-like food is for elderly people or people with difficulties in swallowing.

6. A method for producing a gel-like food comprising 1 to 6% by mass of an egg white protein and 4 to 15% by mass of casein, wherein a total protein content in the gel-like food is 5.5 to 25% by mass, the method comprising coagulating the protein by heating.

7. The method for producing a gel-like food according to claim 6, wherein the casein comprises sodium caseinate and calcium caseinate.

8. The method for producing the gel-like food according to claim 6, further comprising a collagen peptide.
